(19) United States
(12) Patent Application Publication
(10) Pub. No.: US 2015/0107328 A1
(43) Pub. Date: Apr. 23, 2015

(54) Method for Improving Accuracy of Multiphase Mixture Flowrate Measurement in A Pipeline

(71) Applicant: Schlumberger Technology Corporation, Sugar Land, TX (US)

(72) Inventors: Alexander Starostin, Moscow (RU); Andrei Alexandrovich Osiptsov, Moscow (RU)

(21) Appl. No.: 14/513,169

(22) Filed: Oct. 13, 2014

(30) Foreign Application Priority Data
Oct. 18, 2013 (RU) 2013146562

(51) Int. Cl. G01F 25/00

(52) U.S. Cl. CPC G01F 25/0007
USPC 73/1.16

(57) ABSTRACT

To improve the accuracy of multiphase mixture flow rate measurements, properties of a multiphase mixture are determined under conditions expected inside a pipeline and flow regimes are determined for the expected flow rates. Slug reducing parameters of the pipeline are provided at a pipeline section and a flowmeter is installed at the end of that pipeline section.

### CROSS-REFERENCE TO RELATED APPLICATION

This application claims priority to Russian Application No. 2013146562 filed Oct. 18, 2013, which is incorporated herein by reference in its entirety.

### BACKGROUND

The disclosure relates to methods for measuring parameters of multiphase mixtures during transportation via pipelines, in particular, to methods for reducing frequency and volume of liquid plugs (slugs, or volumes of fluid blocking the pipeline cross-sectional area) during measurements of liquid and gas flow rate with conventional flowmeters.

Gas or liquid slugs may occur in pipelines carrying two-phase mixtures consisting of gas and liquid. Periodic alternations of gas and liquid slugs cause pressure oscillations and, therefore, liquid and gas flow rate oscillations. Because of large liquid flow rate oscillations, exact metering of liquid and gas flow rates using conventional flowmeters can become difficult. Pipeline slugging, when pipelines are exposed to rapid changes in volume fraction of fluids, affects the accuracy of measurements. Pipeline slugging may appear even under constant inlet rates of fluids, and may results in strong oscillations of outlet rates and pressure.

Besides, rate and pressure oscillations in a pipeline carrying gas and liquid mixture may cause cracking and, eventually, destroys the pipeline. Causes of liquid plug occurrence and disappearance are related to pipeline route profile and other pipeline characteristics.

There are different known methods for preventing slugging in a gas and liquid mixture stream. For instance, it was proposed to form a high surface tension film at a liquid-gas interface (patent U.S. Pat. No. 3,112,528) to prevent slugging by modifying properties of fluids in a pipeline. It was also suggested to prevent slugs by reducing gas and liquid flow rates (patent U.S. Pat. No. 5,544,672A). However, in case of hydrocarbon production, modifying flow rates or properties of fluids entering a pipeline from wellbores is usually technically impossible. Also, various devices were proposed for separation of gas and liquid mixture into separate phases, gas and liquids, for separate transportation at certain distance followed by merging two streams into one (see, for instance, patent EP 1448871 B1).

### SUMMARY

The disclosure provides for reducing amount, frequency and length of slugs in a flow, as well as for corresponding reduction of magnitude of liquid and gas flow rate oscillations.

Properties of a multiphase mixture under conditions expected inside a pipeline and flow regimes in the pipeline for expected flow rates are determined. Slug reducing parameters of the pipeline are provided at a pipeline section and a flowmeter is installed at the end of that pipeline section.

According to one embodiment of the disclosure, the slug reducing parameters of the pipeline are provided by a downward inclination of the pipeline section in front of the flowmeter location. An angle of the inclination and a length of the inclined section are selected so that a flow regime with slugging becomes the least likely for the expected flow rate values, i.e. to make slugging appear only in a small sub-area of the expected flow rates, or to ensure slugging will not occur at all.

The length of the inclined section can exceed a diameter of the pipeline at least 10 times.

The downward inclination of the section in front of the flowmeter location can be provided by inserting an inclined section into the pipeline in front of the flowmeter location, or by installing the flowmeter at a lower end of the pipeline section that already has the selected inclination.

According to another embodiment of the disclosure the slug reducing parameters of the pipeline are provided by changing a pipeline wall roughness in front of the flowmeter location. Changing of the pipeline wall roughness in front of the flowmeter location can be provided by inserting a section with the required roughness into the pipeline, or by machining pipeline wall surface to achieve the required roughness.

According to yet another embodiment of the disclosure, the slug reducing parameters of the pipeline are provided by changing a diameter of the pipeline or a geometry of the pipeline cross-section by inserting a pipeline section with the required parameters into the pipeline.

The properties of the multiphase mixture being determined are density, viscosity, surface tension, etc.

### BRIEF DESCRIPTION OF DRAWINGS

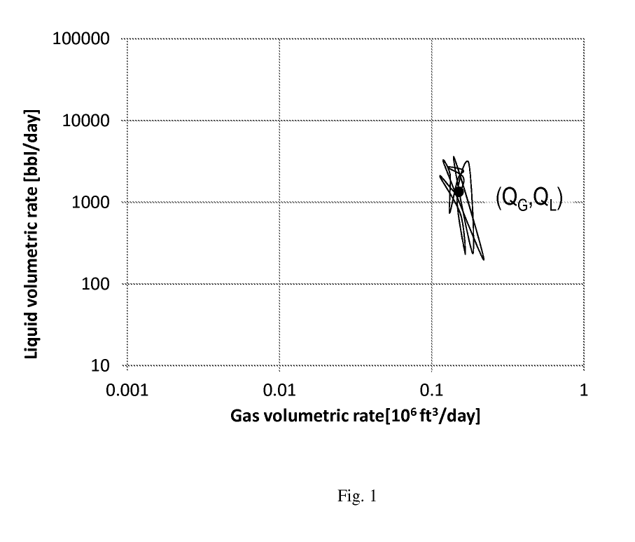

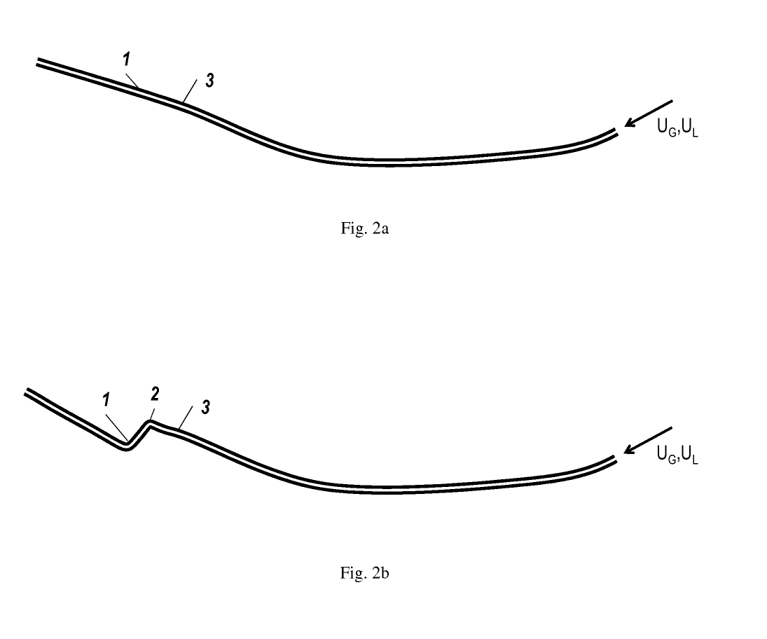

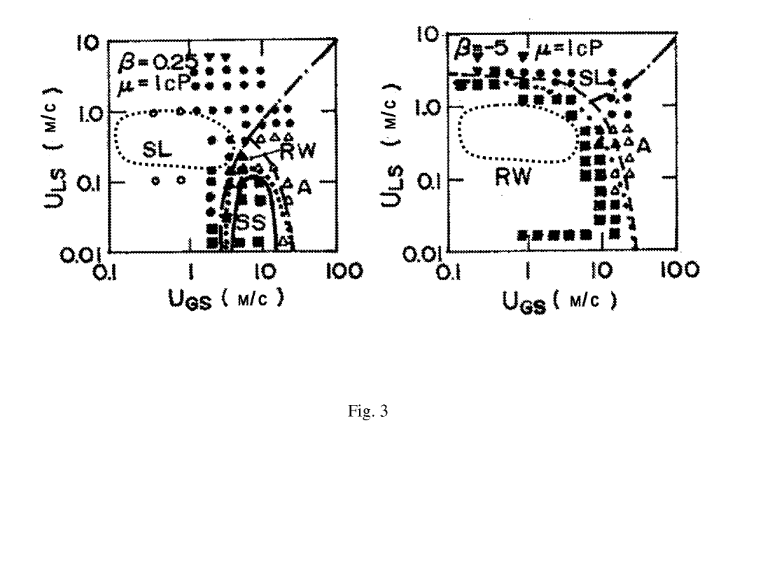

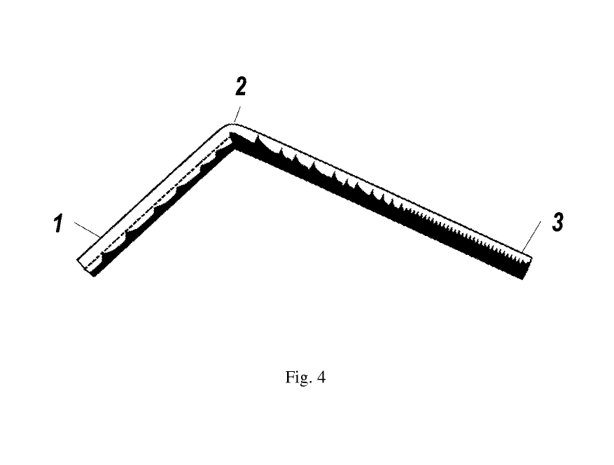

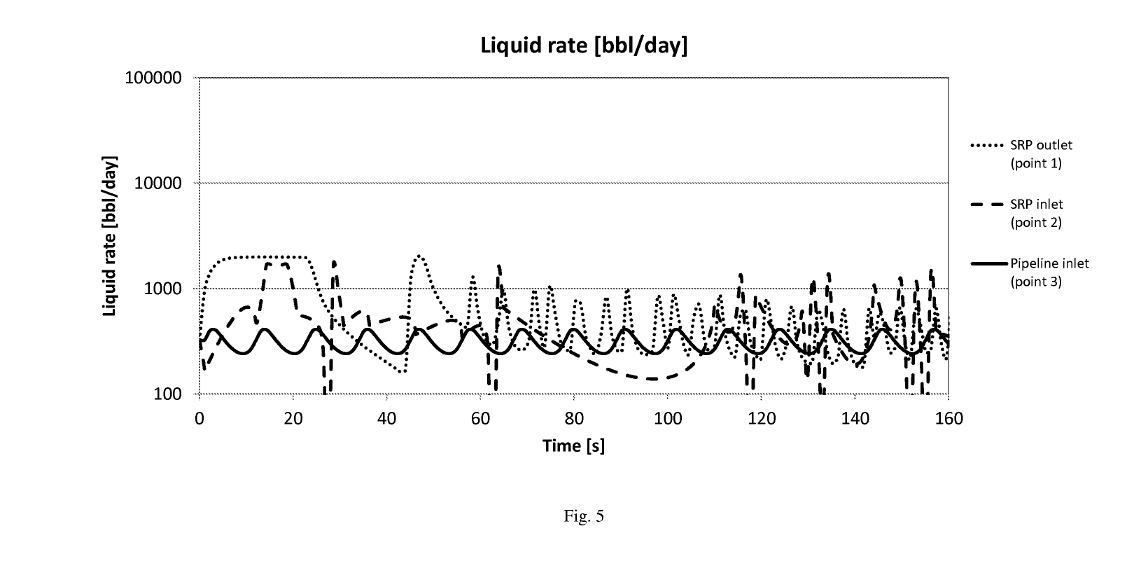

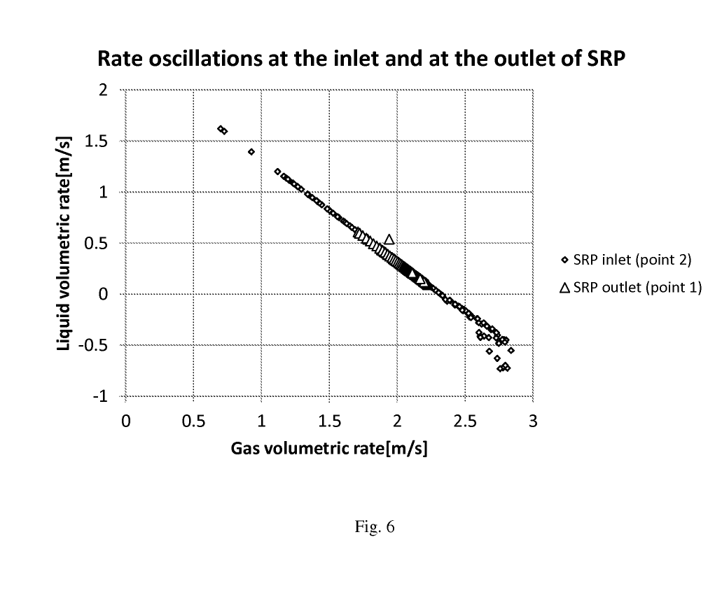

The disclosure is illustrated by the drawings wherein FIG. 1 shows a scheme of flow rates dynamics under fixed rates during slugging in the pipeline; FIG. 2a shows a pipeline profile before insertion of a section reducing slugging; FIG. 2b shows the pipeline profile with inserted section reducing slugging; FIG. 3 shows experimental flow regime charts; FIG. 4 shows a liquid level in the pipeline and in the pipeline inclined section; FIG. 5 shows oscillations of flow rate in various places of the pipeline with the section reducing slugging; FIG. 6 shows gas/water rates cross-plots at the inlet and at the outlet of the slug reducing pipe.

### DETAILED DESCRIPTION

At the first stage, properties of a transported multiphase mixture, such as density, viscosity and surface tension of fluids contained in the mixture, are evaluated under conditions expected in a pipeline. These properties are used in an experiment conducted to study flow regimes or to describe flow regimes using mathematical modeling.

The second stage comprises studying flow regimes in the expected flow rate area. The flow regime can be determined by experiments (e.g., Shoham, Mechanistic Modeling of Gas-Liquid Two-Phase Flow in Pipes, Society of Petroleum Engineers (SPE), Richardson, Tex., 2006, p. 408; Y. V. Fairuzov, 2001, Stability Analysis of Stratified Oil/Water Flow in Inclined Pipelines, SPE Production & Facilities, 16, 1 pp.14-21), or predicted based on flow stability theory (D. Barnea, Y. Taitel, 1994. Interfacial and structural stability of separated flow. Annual Reviews in Multiphase flow, G. Hetsroni, ed., pp. 387-414). The flow regime governs a design of a pipeline section in front of a location of a flowmeter for reducing slugging: slug reducing parameters of the pipeline are provided at the pipeline section and a flowmeter is installed at the end of that pipeline section. Reduced pipeline slugging results in reduced slug length and frequency of slug appearance.

For a complex-shaped pipeline section, effect of inclination angle, a pipeline diameter, a pipeline wall roughness and effects of other parameter on flow regime at the end of the section are considered. The section should be designed so as to minimize liquid and gas flow rate area where pipeline slugging is likely to occur. The third stage is actually providing the pipeline parameters reducing slugging. For example, according to one of the embodiments, a given inclination of the pipeline section is provided in front of the flowmeter location. In particular, an inclination angle (from 0°-10°) and a length of the inclined section (from 10-500 m) for a pipeline diameter 0.01 m-0.5 m are chosen so that slugging would be less likely for the expected flow rates (i.e. that slugging would occur in a small sub-area of expected flow rates, or would not occur at all). The length of the inclined section can be at least 10 times as large as the pipeline diameter.

The pipeline parameters reducing slugging can be provided by modifying a pipeline wall roughness in front of the flowmeter location. The pipeline wall roughness can be modified by inserting a section with a required roughness into the pipeline, or by machining a pipeline wall surface to achieve the required roughness.

Besides, the parameters reducing slugging can be provided by modifying a pipeline diameter or geometry of the pipeline cross-section by inserting a pipeline section with the required parameters.

Below is an example of embodiment using Vx technology to change volume fraction of fluid in a pipeline section. Vx Phasetester flowmeter measures volume fraction of fluids by changes in pressure drop across the Venturi tube and by interpreting gamma-day mixture density data. (http ://www.slb.com/˜/media/Files/testing/product_sheets/multiphase/phasetester_ps.pdf). The flowmeter can only be used in a certain gas and liquid flow rate area, in particular, this flowmeter is not suitable for low liquid rates. FIG. 1 shows volume flow rate area where the Vx devices can operate and a scheme of flow rates dynamics under fixed rates during slugging in the pipeline.

At fixed pipeline rates at a pipeline inlet, slugging causes severe oscillations of fluid flow rates at a distance from the pipeline inlet. Besides, flow rate values can go beyond the instrument range. The disclosure is aimed at reducing pipeline slugging and achieving steady flow rate values within the range of applicability.

For example, measurements are necessary for air-water flow in a 10-cm diameter pipeline. Fluids enter into a flowmeter under standard conditions. First, fluid properties (density, viscosity, surface tension) should be evaluated.

The flowmeter is installed at point 1. A pipeline section 1-3 has an upward inclination (FIG. 2a). Then the flow rate areas where slugging occurs are found for the fluids on flow regime charts. The flow regime charts can be obtained experimentally. For this purpose, a model of the pipeline section 1-3 is created and a series of fluid injections is performed at constant flow rates. The flow regime at the outlet of the pipeline is recorded at fixed input rates, for instance, flow regimes can be observed visually through a glass inserted into the pipeline. The flow regime is then plotted at the point which corresponds to the fixed input rate value. The selected section has ˜0.25° inclination. The flow regime chart (FIG. 3) shows that volume flow rate of gas from 0.1 to 1 m/s would always cause slugging (plugging). FIG. 3 shows squares—observed regime with smooth phase interface; triangles are observed regime with waves on phase interface; circles are observed slugging flow regime. According to the chart, the air-water flow with upward inclination is favorable for slugging. The air-water flow with downward inclination has the flow pattern reducing slugging in the domain ranged with dashed line.

However, this changes if a downward inclination in 5° is provided at the pipeline section 1-3 (FIG. 4, FIG. 5). Thus, if a pipeline profile is changed from 1-3to 1-2-3, the flow regime inside the pipeline will be changed from slugging to stratified flow for gas velocities from 0.1 to 1 m/s. Stratified flow regime helps improve measurement accuracy. This area is shown as dotted lines on flow regime charts on FIG. 3. Disturbance decay evaluation can be made according to works on linear stability of multiphase flows (D. Barnea, Y. Taitel, 1994. Interfacial and structural stability of separated flow. Annual Reviews in Multiphase flow, G. Hetsroni, ed., pp. 387-414).

To dampen the slugs coming into point 2, 100 m section can be allocated. The pipeline section 1-2-3 (FIG. 2b) is designed to reduce slugging, it contains a 100-m pipeline section from point 1 to 2 inclined downward.

Mathematical modeling can also be used for pipeline design. Mathematical model of a multiphase flow in a pipeline ending with an inclined section can be used to evaluate decay of disturbances in point 1 (FIG. 5, FIG. 6). FIG. 5 shows flow rate oscillations at various points along the pipeline. FIG. 6 shows gas/water rates cross-plots at the inlet and at the outlet of the slug reducing section. Oscillation amplitude is reduced in 2 times, low and negative liquid flow rates were also eliminated.

The third stage is to provide a downward inclination at the required point. The inclination can be provided by installing an inclined section into the pipeline. The original pipeline and its modification are shown on FIG. 2. It is also possible to inspect the pipeline and identify an existing pipeline section with 5° downward inclination, with length 100 m. The flowmeter should be installed at the bottom part of this section.

1. A method for improving accuracy of multiphase mixture flow rate measurement in a pipeline, comprising:
determining properties of a multiphase mixture under conditions expected inside the pipeline,
determining flow regimes in the pipeline for expected flow rates,
providing slug reducing parameters of the pipeline at a pipeline section and installing a flowmeter at the end of the pipeline section.

2. The method of claim 1, wherein the properties of the multiphase mixture are density, viscosity and surface tension.

3. The method of claim 1, wherein the slug reducing parameters of the pipeline are provided by a downward inclination of the pipeline section in front of the flowmeter location, an angle of the inclination and a length of the pipeline section are selected so that a flow regime with slugging becomes the least likely for the expected flow rates.

4. The method of claim 3, wherein the length of the pipeline section exceeds a diameter of the pipeline at least 10 times.

5. The method of claim 3, wherein the downward inclination of the pipeline section before the flowmeter location is provided by inserting an inclined section into the pipeline in front of the flowmeter location.

6. The method of claim 3, wherein the downward inclination of the pipeline section in front of the flowmeter location is provided by installing the flowmeter at the bottom part of a pipeline section having the selected inclination angle.

7. The method of claim 1, wherein the slug reducing parameters of the pipeline are provided by changing a pipeline wall roughness in front of the flowmeter location.

8. The method of claim 7, wherein changing of the pipeline wall roughness in front of the flowmeter location is provided by inserting a pipeline section with a required wall roughness.

9. The method of claim 7, wherein changing of the pipeline wall roughness in front of the flowmeter location is provided by machining pipeline walls.

10. The method of claim 1, wherein the slug reducing parameters of the pipeline are provided by changing a diameter of the pipeline or a geometry of cross-section of the pipeline by inserting a pipeline section with the required parameters into the pipeline.
